(19) United States
(12) Patent Application Publication
(10) Pub. No.: US 2017/0341348 A1
(43) Pub. Date: Nov. 30, 2017

(54) METHOD FOR PRODUCING A COMPOSITE, AND A COMPOSITE

(71) Applicant: EMERELL AG, Sempach Station (CH)

(72) Inventors: Jörg VORTKORT, Wulfsen (DE); Adrian SCHULTHESS, Tentlingen (CH)

(21) Appl. No.: 15/536,253

(22) PCT Filed: Dec. 16, 2015
(86) PCT No.: PCT/EP2015/079977

§ 371 Date: Jun. 15, 2017

(30) Foreign Application Priority Data
Dec. 19, 2014 (DE) 14199466.5

(51) Int. Cl. B32B 27/08; B32B 5/02; B32B 27/12

(52) U.S. Cl. CPC B32B 27/08; B32B 27/12; B32B 5/024; B32B 5/026; B32B 5/028; B32B 5/022; B32B 2307/724; B32B 2307/7265; B32B 2419/00; B32B 2605/00

(57) ABSTRACT

A composite and a method for producing a composite (1) of at least three layers, comprising a support (2), in particular a woven fabric, knitted fabric, net, non-woven fabric, mesh, or non-crimp fabric, a first polymer layer (3) which faces the support, and a second polymer layer (4) which faces away from the support and adjoins the first polymer layer (3). The at least three layers are combined under pressure and temperature conditions which are selected such that an at least partial penetration of the first polymer layer (3) into the support (2) is ensured, wherein the composite adhesion between the first polymer layer (3) and the support (2) is at least ≧0.2 N/mm.

The invention relates to a process for the production of a composite made of at least three layers, and also a composite as per the preambles of the independent claims.

Multilayer composites are produced by composite-production processes. A frequent requirement here is to ensure that processes are appropriate and efficient.

Processes for the production of composites are known, as also are multilayer composites. Such a composite is described by way of example in EP 0 966 352 B1. A polyamide polymer film has layers made of films with melting point below 220° C., where the polyamide of the polymer film must meet certain requirements relating to the underlying backbone of the polymer, in particular the alkyl branching. The polyamide polymer film has been bonded to a woven fabric made of polyamide or polyester.

EP 1 518 761 describes a laminate material with a polymer film and a supportive layer. The polymer film has two layers. The first layer here is formed from a material with glass transition temperature below −10° C., and the second is formed from a material with glass transition temperature below 20° C.

DE 197 19 655 A1 describes a water-resistant membrane with masonry-bonding capability. A laminate or a membrane forms a water-resistant, fracture-preventing layer when used between a masonry substrate and an article applied externally on the masonry, for example a ceramic tile.

However, adequate bond strength is not ensured here.

It is therefore an object of the invention to overcome the disadvantages of the prior art and in particular to provide a multilayer composite which ensures a defined strength of the bond between a backing and a superposed polymer layer.

The object is achieved in the invention via a process for the production of a composite and a composite as per the features of the independent claims.

The invention relates to a process for production of a composite made of at least three layers. The at least three layers are composed of a backing, in particular a woven fabric, knitted fabric, net, nonwoven fabric, mesh or laid scrim, a first polymer layer facing toward the backing and, adjacent to the first polymer layer, a second polymer layer facing away from the backing. The at least three layers here are combined under conditions of pressure and temperature selected in such a way as to ensure at least partial penetration of the first polymer layer into the backing. The strength of the bond between the first polymer layer and the backing is at least ≧0.2 N/mm. A composite with a defined bond strength is thus provided. In particular, adequate strength of the bond between the backing and the first polymer layer facing toward the backing is ensured. Robust and strong composites are thus produced which, as described below, have other advantageous properties.

Bond strengths as described here and hereinafter are measured by a standard method on a sample of the composite as described below. Adhesive tapes with adhesion of at least 0.3 N/mm to the surface, preferably 0.5 N/mm, are applied to both sides of the sample. The composite is tested in a 90° peel test in a tensile testing system, the measurement being made in accordance with DIN 53550 “Separation test on adhesively bonded fabric plies”.

For the purposes of the process of the invention, the design of the second polymer layer can be such that it does not penetrate into the backing. The functionality of the second polymer layer is thus not impaired. Adhesion to the backing is provided only by the first polymer layer, while the second polymer layer, which is adjacent to the first polymer layer and which faces away from the backing, provides specific properties of the composite.

The design of the first polymer layer is preferably such that it does not fully penetrate the backing. Partial penetration of the first polymer layer into the backing is thus ensured. The quantity of material that has to be provided is therefore comparatively small, and in particular the first polymer layer that has to be provided is therefore comparatively thin.

The at least three layers can be provided in succession, in particular in a cascade extrusion process. It is likewise possible to provide a composite made of a backing and of a first polymer layer. A second polymer layer is applied, in particular applied by extrusion, onto this composite. It is also optionally possible that the first polymer layer is applied, in particular coextruded, together with the second polymer layer onto the backing. It is thus possible to implement the production process on existing manufacturing lines.

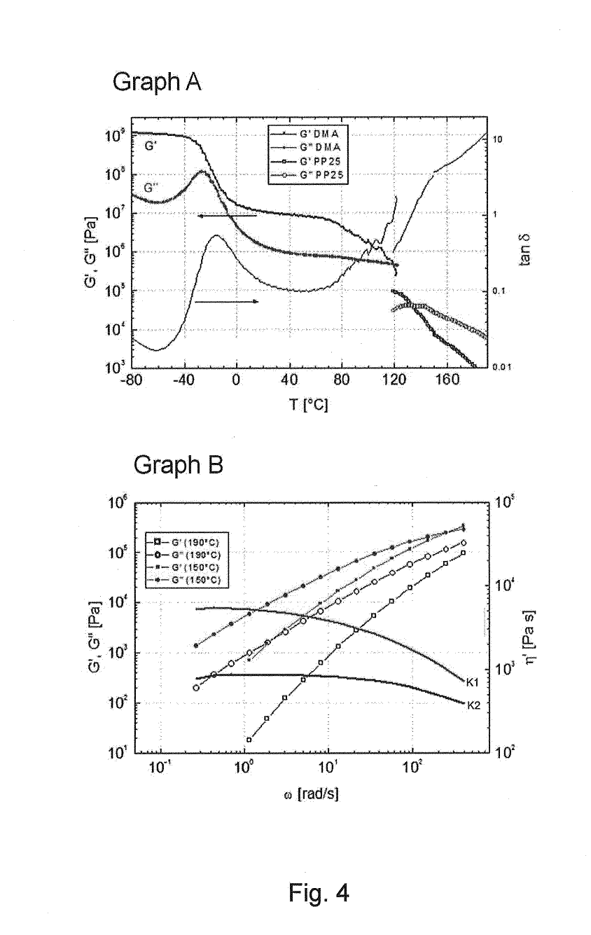

The viscosity of the first polymer layer can be lower than that of the second polymer layer. However, the viscosity of the first polymer layer here is at least ≧100 Pa*s. Viscosity is determined by a rotary viscometer, for example a Physica MCR 301 from Anton Paar, and a temperature and frequency sweep is measured (cf. viscosity measurement example in FIG. 4 and description of FIG. 4). The abovementioned lower viscosity ensures optimized application of the first layer onto the backing, and also no substantial mixing of the first and second polymer layer, or flow of these into one another, during the production process.

The second polymer layer can be impermeable to liquid, in particular impermeable to water, and permeable to gas, in particular permeable to water vapor. The abovementioned advantageous properties relate, of course, to the second polymer layer in the final or functional condition of the composite, i.e. after conclusion of, and not during, the production process. The second polymer layer thus serves as barrier for substances in the liquid state, in particular as barrier for liquid water, while substances in the gas phase, in particular water vapor, can pass through the composite for gas-exchange purposes.

With the process of the invention it is moreover also possible that a further, third polymer layer is applied, in particular applied by extrusion, onto the second polymer layer. Alternatively, it is possible that the first polymer layer is applied, in particular coextruded, together with the second polymer layer and a third polymer layer onto the backing. The properties of this third polymer layer correspond in essence to the properties of the first polymer layer which have already been explained above.

It is possible that a further, second backing, in particular a woven fabric, knitted fabric, net, nonwoven fabric, mesh or laid scrim, is applied onto the third polymer layer. A five-ply composite is thus provided with the following layer sequence: (i) backing, (ii) first polymer layer, (iii) second polymer layer, (iv) third polymer layer and (v) second backing. Good adhesion to the second backing is provided by means of the third polymer layer.

For the purposes of the process of the invention, the design of the second polymer layer can be such that it does not penetrate into the second backing. The functionality of the second polymer layer is thus not impaired. Adhesion to the second backing superposed on the third polymer layer is provided only by the third polymer layer, while specific properties of the composite are provided by the second polymer layer positioned between the first and the third polymer layers.

The design of the third polymer layer can moreover be such that it does not fully penetrate the second backing. In this way, partial penetration of the third polymer layer into the second backing is ensured. The quantity of material that has to be provided is therefore comparatively small, and in particular a first polymer layer that has to be provided is therefore comparatively thin.

A further aspect of the invention provides a composite obtainable by a process as explained above. The composite has at least three layers. The at least three layers are composed of a backing, in particular a woven fabric, knitted fabric, net, nonwoven fabric, mesh or laid scrim, a first polymer layer facing toward the backing and, adjacent to the first polymer layer, a second polymer layer facing away from the backing. The at least three layers here are combined under conditions of pressure and temperature selected in such a way as to ensure at least partial penetration of the first polymer into the backing. The strength of the bond between the first polymer layer and the backing is at least ≧0.2 N/mm. A composite with a defined bond strength is thus provided. In particular, adequate strength of the bond between the backing and the first polymer layer facing toward the backing is ensured. A robust and strong composite is thus produced which has advantageous properties.

The second polymer layer of the composite can be impermeable to liquid, in particular impermeable to water, and permeable to gas, in particular permeable to water vapor. The second polymer layer thus serves as barrier for substances in the liquid state, in particular as barrier for liquid water, while substances in the gas phase, in particular water vapor, can pass through the composite for gas-exchange purposes.

It is moreover possible that a further, third polymer layer is superposed, in particular applied by extrusion, onto the second polymer layer. Alternatively, it is possible that the first polymer layer is applied, in particular coextruded, together with the second polymer layer and a third polymer layer onto the backing. The properties of said third polymer layer correspond in essence to the properties of the first polymer layer which have already been explained above.

It is possible that a further, second backing, in particular a woven fabric, knitted fabric, net, nonwoven fabric, mesh or laid scrim, is applied onto the third polymer layer. A five-ply composite is thus provided which has been explained above. The third polymer layer provides good adhesion to the second backing.

For the purposes of the process of the invention, the design of the second polymer layer can be such that it has not penetrated into the backing. The functionality of the second polymer layer is thus not impaired. Adhesion to the backing is provided only by the first polymer layer, while the second polymer layer, which is adjacent to the first polymer layer and which faces away from the backing, provides specific properties of the composite.

The design of the first polymer layer can moreover be such that it does not fully penetrate the backing. Partial penetration of the first polymer layer into the backing is thus ensured. The quantity of material that has to be provided is therefore comparatively small, and in particular a first polymer layer that has to be provided is therefore comparatively thin.

The design of the second polymer layer can be such that for the purposes of the process of the invention it does not penetrate into the second backing. The functionality of the second polymer layer is thus not impaired. Adhesion to the second backing superposed on the third polymer layer is provided only by the third polymer layer, while specific properties of the composite are provided by the second polymer layer positioned between the first and the third polymer layers.

The design of the third polymer layer can moreover be such that it does not fully penetrate the second backing. Partial penetration of the third polymer layer into the second backing is thus ensured. The quantity of material that has to be provided is therefore comparatively small, and in particular a first polymer layer that has to be provided is therefore comparatively thin.

A further aspect of the invention provides the use of a composite as explained above as roof-liner sheeting, or as water-vapor-permeable membrane for buildings, shoes or textiles. There are moreover advantageous uses in the automobile industry, preferably as cabriolet cover, parcel shelf, vehicle-trunk lining or vehicle-roof lining. It is thus possible to use the advantageous properties of the composite for specific purposes.

Physical Parameters:

The weight per unit area of the backings used is preferably from 5 g/m² to 300 g/m², particularly preferably from 10 g/m² to 150 g/m². The weight per unit area of the first polymer layer is preferably from 5 g/m² to 100 g/m², particularly preferably from 10 g/m² to 50 g/m². The weight per unit area of the second polymer layer is preferably 10 g/m² to 250 g/m², particularly preferably from 20 g/m² to 200 g/m². The weight per unit area of the third polymer layer is preferably that of the first polymer layer.

Preferred weights per unit area for a composite made of a backing and two polymer layers are from 20 g/m² to 150 g/m² for the backing, from 10 g/m² to 50 g/m² for the first polymer layer and from 20 g/m² to 200 g/m² for the second polymer layer.

Preferred weights per unit area for a composite made of two backings and three polymer layers are from 10 g/m² to 150 g/m² for the first backing, from 10 g/m² to 50 g/m² for the first polymer layer and from 20 g/m² to 200 g/m² for the second polymer layer, from 10 g/m² to 50 g/m² for the third polymer layer and from 10 g/m² to 150 g/m² for the second backing.

Chemical Compositions or Components of the Polymer Layers

Suitable materials for the provision, in particular the extrusion of the polymer layers are extrudable polymers. Suitable materials are preferably polyolefins, polyamides, polyesters, polyurethanes and mixtures thereof. For applications as membrane, for example as roof-lining sheeting, it is particularly preferable to use a thermoplastic polyurethane material, in particular a polyether polyurethane, preferably Desmopan 9370 A from Bayer. Elastollan 1075 A 10U from BASF, in particular MFR 84 g/10 min measured using 190° C./21.6 kg, MFR 49 g/10 min measured using 190° C./21.6 kg or MFR 20 g/min measured using 190° C./21.6 kg is particularly suitable as thermoplastic material. Other suitable materials, alongside polyurethanes, are water-vapor-permeable copolyesters such as Arnitel. Particularly suitable materials are Arnitel P or V products, for example Arnitel VT 3104 MFR 14 g/19 min measured using 230° C./2.16 kg or Arnitel VT 3108 MFR 10 g/min measured using 230° C./2.16 kg.

An example of a preferred nonwoven fabric is a nonwoven polyester fabric (PES) or a nonwoven polyester/polypropylene fabric (PES/PP) or a nonwoven polypropylene fabric (PP). The nonwoven fabrics have been chemically or thermally consolidated, needled or hydroentangled. Examples are nonwoven polyester fabric WJ 120PET-6700-90 120 g/m² from GS-Vliesstoffe, nonwoven polyester fabric 3201A 20 g/m² from GS-Vliesstoffe, nonwoven polyester fabric PET 080 OV 80 g/m² from GS-Vliesstoffe, spunbond nonwoven PP fabric 90 g/m² from GS-Vliesstoffe and 70 g/m² spunbond nonwoven PP fabric from DON & LOW, and nonwoven fabrics made of thermoplastic polyurethanes, for example TPU MB 2ES100 100 g/m² from Innovatec.

### INVENTIVE EXAMPLES

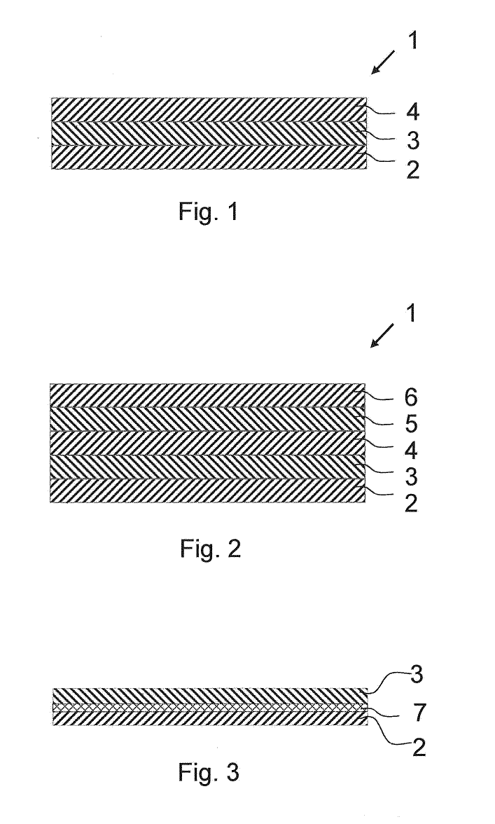

Example 1 is a multilayer composite made of a backing and two polymer layers (cf. FIG. 1). The backing comprises spunbond nonwoven PP fabric 90 g/m² (GS-Vliesstoffe). The first polymer layer facing toward the backing comprises Ellastollan 1075AU10 MFR 84 g/10 min, 10 g/m². Adjacent to the first polymer layer, the second polymer layer facing away from the backing comprises Elastollan 1075AU10 MFR 20 g/10 min, 70 g/m².

Example 2 is a multilayer composite made of two backings and three polymer layers (cf. FIG. 2). The first and the second backing comprise spunbond nonwoven PP fabric, 70 g/m² (DON & LOW). The first polymer layer facing toward the first backing and the third polymer layer facing toward the second backing comprise Elastollan 1075AU10 MFR 84 g/10 min, 20 g/m². Adjacent to the first and third polymer layer, the second polymer layer facing away from the backings comprises Elastollan 1075AU10 MFR 20 g/10 min, 50 g/m².

The invention is explained in more detail below with reference to depictions of inventive examples.

FIG. 1: is a diagram of a three-layer composite of the invention;

FIG. 2: is a diagram of a preferred five-layer composite;

FIG. 3: is a diagram of partial penetration of the first polymer layer into the adjacent backing;

FIG. 4: is a diagram of an example of viscosity measurement.

FIG. 1 shows a three-layer composite 1 which is composed of a backing 2, a first polymer layer 3 facing toward the backing 2 and a second polymer layer 4 facing away from the backing 2 and superposed on the first polymer layer 3 (cf. example 1). The second polymer layer 4 here does not penetrate substantially into the first polymer layer 3. It moreover does not penetrate into the backing 2.

FIG. 2 shows an alternative, preferred five-layer composite 1 (cf. example 2). The composite 1 has the following sequence of components: backing 2, first polymer layer 3, second polymer layer 4, third polymer layer 5 and second backing 6. The first polymer layer 3 and the third polymer layer 4 are in essence identical in their physical properties and chemical composition. The first polymer layer 3 provides the adhesion to the backing 2. The third polymer layer provides the adhesion to the second backing 6. The second polymer layer 4 has accordingly been positioned between the first polymer layer 3 and the third polymer layer 5, and is not in contact with the backing 2 and the second backing 6. The second polymer layer 4 is preferably impermeable to water and permeable to water vapor.

FIG. 3 is a diagram of a backing 2 and a first polymer layer 3 (cf. FIGS. 1 and 2; no other layers being shown). The backing 2 comprises a region 7. The design of the first polymer layer 3 is such that it penetrates partially into the backing 2 during the production of the composite 1 with resultant optimized adhesion. The region 7 corresponds to that region of the backing 2 into which the first polymer layer 3 has partially penetrated. The first polymer layer 3 does not fully penetrate the backing 2 here.

In the case of a five-ply composite (cf. FIG. 2), there is identical partial penetration (not shown) of the third polymer layer 4 into the second backing 6.

FIG. 4 shows the graphs A and B relating to an example of measurement of viscosity in a rotary viscometer. Graph A shows the dynamic-mechanical analysis and rheology (abbreviated to DMA). Graph B shows isothermal frequency responses. A thermoplastic adhesive film based on polyurethanes was used, marketed as Collano 36.304. The viscosity of the first layer is measured in a Physica MCR 301 rotary viscometer in a plate-on-plate arrangement with plate diameter 25 mm (abbreviated to PP25 in graph A). The temperature sweep is started where the first layer becomes liquid. This is the case above 120° C. in the example (cf. graph A). The frequency sweep is carried out at constant temperature. The frequency was 1 Hz. Heating rate was 3 K/min. The temperature is selected in such a way that the polymer layer is liquid. The frequency is varied from 0.1 rad/sec to 1000 rad/sec. In the isothermal frequency response, the first curve (K1) describes viscosity as a function of frequency at 150° C. (cf. graph B). The second curve (K2) describes the viscosity as a function of frequency at 190° C. (cf. graph B). The zero viscosity (η′₀) in the case of the selected polymer is 5500 Pa*s at 150° C. and 900 Pa*s at 190° C. The equipment indicates the resistance of the viscoelastic melt to deflection in the form of shear modulus or loss modulus or in the form of viscosity.

Collano 36.304

Tₘ (rheo)=120° C.

T_{g}=−27° C.

η′₀ (150° C.)=5500 Pa*s

η′₀ (190° C.)=900 Pa*s

1-14. (canceled)

15. A process for production of a composite made of at least three layers comprising:
a backing,
a first polymer layer facing toward the backing,
a second polymer layer, adjacent to the first polymer layer, facing away from the backing,
wherein said at least three layers are combined under conditions of pressure and temperature selected in such a way as to ensure at least partial penetration of said first polymer layer into said backing, where the strength of the bond between said first polymer layer and said backing is at least ≧0.2 N/mm.

16. The process as claimed in claim 15, wherein a viscosity of said first polymer layer is lower than a viscosity of said second polymer layer.

17. The process as claimed in claim 16, wherein said viscosity of said first polymer layer is at least ≧100 Pa*s.

18. The process as claimed in claim 15, wherein said second polymer layer does not penetrate into said backing.

19. The process as claimed in claim 15, wherein said first polymer layer does not fully penetrate the backing.

20. The process as claimed in claim 15, wherein
said at least three layers are provided in succession; or
a composite made of backing and of first polymer layer is provided and said second polymer layer is applied; or
said first polymer layer is applied together with said second polymer layer onto said backing.

21. The process as claimed in claim 15, wherein said second polymer layer is impermeable to liquid but permeable to gas.

22. The process as claimed in claim 15, wherein a third polymer layer is applied onto said second polymer layer, or said first polymer layer is applied together with said second polymer layer and a third polymer layer onto said backing.

23. The process as claimed in claim 22, wherein a second backing is applied onto said third polymer layer.

24. A composite obtainable by a process as claimed in claim 15.

25. The composite as claimed in claim 24, wherein said second polymer layer is impermeable to liquid but permeable to gas.

26. The composite as claimed in claim 24, wherein a third polymer layer is applied onto said second polymer layer, or said first polymer layer is applied together with said second polymer layer and a third polymer layer onto said backing.

27. The composite as claimed in claim 26, wherein a second backing is applied onto said third polymer layer.

28. The composite as claimed in claim 24, wherein said second polymer layer does not penetrated into said backing.

29. The composite as claimed in claim 24, wherein said first polymer layer does not fully penetrate said backing.
